(19) United States
(12) Patent Application Publication
(10) Pub. No.: US 2023/0313890 A1
(43) Pub. Date: Oct. 5, 2023

(54) FLUID END VALVE

(71) Applicant: Kerr Machine Co., Sulphur, OK (US)

(72) Inventors: Kelcy Jake Foster, Ardmore, OK (US); Micheal Cole Thomas, Ardmore, OK (US); Christopher Todd Barnett, Stratford, OK (US); Nicholas Son, Davis, OK (US); John Keith, Ardmore, OK (US)

(21) Appl. No.: 18/193,720

(22) Filed: Mar. 31, 2023

Related U.S. Application Data
(60) Provisional application No. 63/326,325, filed on Apr. 1, 2022.

(51) Int. Cl. F16K 1/38; F16K 1/42; F16K 25/04; F16K 15/06

(52) U.S. Cl. CPC F16K 1/38; F16K 1/42; F16K 25/04; F16K 15/066

(57) ABSTRACT

A valve having a nose joined to a strike face. The strike face is configured to engage a tapered sealing surface formed on a component having a central fluid bore. The valve and component are configured to be installed within a fluid end. When the strike face of the valve engages the tapered sealing surface of the component, the nose is installed within the central fluid bore of the component. In operation, fluid is restricted from flowing between the strike face and the tapered sealing surface until fluid pressure has pushed the nose entirely out of the central fluid bore, thereby increasing the cross-sectional area available for fluid flow.

### RELATED APPLICATIONS

This application claims the benefit of U.S. provisional patent application Ser. No. 63/326,325, authored by Foster et al., and filed on Apr. 1, 2022, the entire contents of which are incorporated herein by reference.

### SUMMARY

The present invention is directed to a valve configured to seal against a component. The component has a first tapered sealing surface joined to a central fluid bore. The valve comprises a valve body having a nose. The valve body comprises a second tapered sealing surface that is configured to seal against the first tapered sealing surface. The nose has a cylindrical shape and is sized to be closely received within at least a portion of the central fluid bore.

### BRIEF DESCRIPTION OF THE DRAWINGS

FIG. 1 is a cross-sectional view of a fluid end known in the art having a fluid end valve known the art installed therein.

FIG. 2 is an enlarged view of area A, shown in FIG. 1, but also includes fluid arrows representing fluid flow.

FIG. 3 is an enlarged view of area, B shown in FIG. 1.

FIG. 4 is a side elevational view of one embodiment of a valve 40 disclosed herein.

FIG. 5 is a front perspective view of the valve shown in FIG. 4.

FIG. 6 is a front plan view of the valve shown in FIG. 4.

FIG. 7 is a cross-sectional view of the valve shown in FIG. 6, taken along line C-C.

FIG. 8 is the cross-sectional view of the fluid end shown in FIG. 1, but the valve shown in FIG. 4 is installed therein.

FIG. 9 is an enlarged view of area D, shown in FIG. 8.

FIG. 10 is an enlarged view of area E, shown in FIG. 8.

FIG. 11 is a perspective view of one embodiment of a fluid end attached to one embodiment of a power end.

FIG. 12 is a cross-sectional view of one of the fluid end sections shown in FIG. 11, taken along line F-F having another embodiment of a valve disclosed herein installed within the fluid end section. Various components attached to the fluid end section and the power end have been removed for clarity.

FIG. 13 is a perspective view of the discharge surface of the fluid routing plug shown installed within the fluid end section in FIG. 12.

FIG. 14 is a perspective view of the suction surface of the fluid routing plug shown in FIG. 13.

FIG. 15 is an enlarged view of area G, shown in FIG. 12. The valve is shown in a closed position.

FIG. 16 is the enlarged view shown in FIG. 15, but the valve is shown in an open position.

FIG. 17 is an enlarged view of area H, shown in FIG. 12. The valve is shown in an open position.

FIG. 18 is the enlarged view shown in FIG. 17, but the valve is shown in a closed position.

FIG. 19 is a side elevational view of another embodiment of a valve disclosed herein.

FIG. 20 is a front perspective view of the valve shown in FIG. 19.

FIG. 21 is a front plan view of the valve shown in FIG. 19.

FIG. 22 is a cross-sectional view of the valve shown in FIG. 21, taken along line I-I.

FIG. 23 is a front perspective and exploded view of the valve shown in FIG. 19.

FIG. 24 is the cross-sectional view of the fluid end shown in FIG. 1, but another embodiment of a valve disclosed herein is shown installed within the fluid end.

FIG. 25 is an enlarged view of area J, shown in FIG. 24, but also includes fluid arrows representing fluid flow.

FIG. 26 is an enlarged view of area K, shown in FIG. 24, but also includes fluid arrows representing fluid flow.

FIG. 27 is a rear perspective view of the valve shown in FIG. 24.

FIG. 28 is a front perspective view of the valve shown in FIG. 27.

FIG. 29 is a side elevational view of the valve shown in FIG. 27.

### DETAILED DESCRIPTION

High pressure reciprocating pumps typically comprise a power end assembly attached to a fluid end assembly. Fluid end assemblies are typically used in oil and gas operations to deliver highly pressurized corrosive and/or abrasive fluids to piping leading to a wellbore. The assemblies are attached to power ends run by engines. The power end comprises a crankshaft that is connected to a plurality of plungers installed within the fluid end assembly. Rotation of the crankshaft causes the plungers to reciprocate within the fluid end assembly, thereby pumping fluid throughout the fluid end assembly.

Fluid may be pumped through the fluid end at pressures that range from 5,000-15,000 pounds per square inch (psi). However, the pressure may reach up to 22,500 psi. Power ends typically have a power output of at least 2,250 horsepower during hydraulic fracturing operations. A single fluid end typically delivers a fluid volume of about 185-690 gallons per minute or 4-16 barrels per minute during a fracking operation. When a plurality of fluid ends are used together, the fluid ends may collectively deliver about 4,200 gallons per minute or 100 barrels per minute to the wellbore.

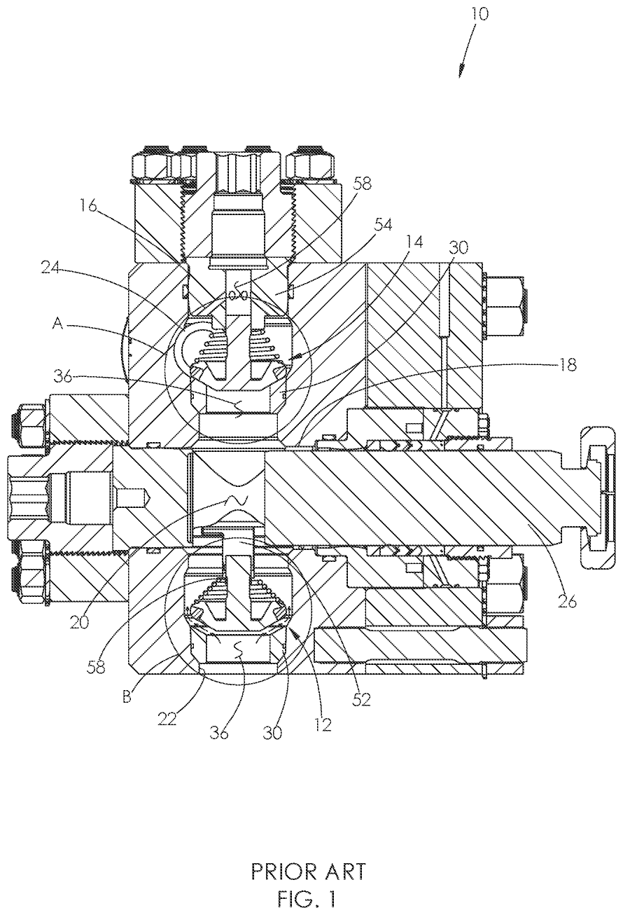

Turning now to the figures, a fluid end 10 known in the art is shown in FIG. 1. The fluid end 10 comprises a vertical bore 16 that intersects a horizontal bore 18 to form a central chamber 20. A pair of fluid end valves known in the art— a suction or inlet valve 12 and a discharge valve 14 are installed within the fluid end 10 and positioned on opposite sides of the central chamber 20. The valves 12 and 14 are each configured to seat against a valve seat 30. During operation, the valves 12 and 14 continually move between open and closed positions to route fluid throughout the interior of the fluid end 10.

Continuing with FIG. 1, as discussed above, a power end reciprocates a plunger 26 within the fluid end 10 to pressurize fluid contained therein. As the plunger 26 retracts from the fluid end 10, low pressure fluid is drawn into the central chamber 20 through a suction opening 22 and the suction valve 12. As the plunger 26 extends into the fluid end 10, fluid within the central chamber 20 is pressurized and forced towards a discharge conduit 24 through the discharge valve 14. The various components of the fluid end 10 are described in more detail in U.S. Issued U.S. Pat. No. 11,536,267, issued to Nowell et al., the entire contents of which are incorporated herein by reference.

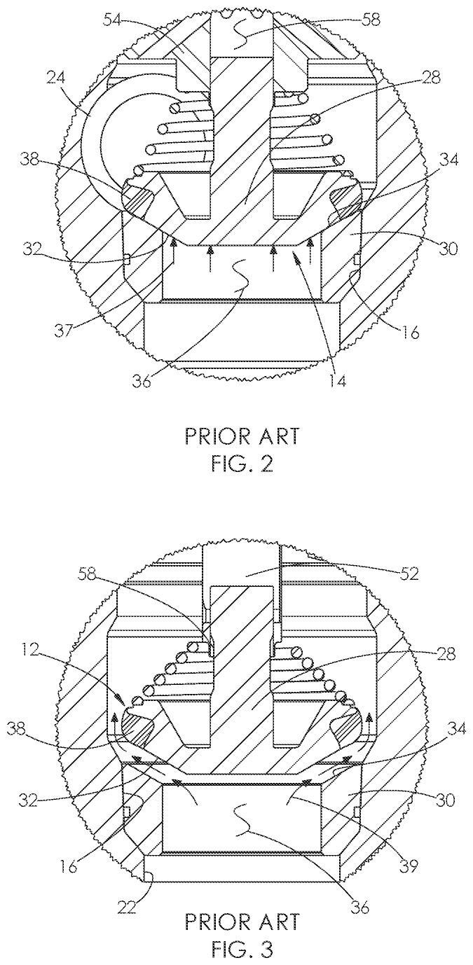

Turning to FIGS. 2 and 3, the suction and discharge valves 12 and 14 shown in FIGS. 1-3 are identical and each comprises a valve body 28 having a seal 38 installed therein. The valve body 28 comprises a tapered strike face 32 sized to mate with a tapered sealing surface 34 formed in the valve seat 30, as shown in FIG. 2. The valve seat 30 is sized to engage the walls of the vertical bore 16 and further comprises a central fluid passage 36. The valve seat 30 may be characterized as a “component” that the valve 12 or 14 is configured to seal against.

The valves 12 and 14 are each configured to move between an open and closed position while the valve seat 30 remains stationary within the fluid end 10, as shown in FIGS. 2-3. When in the closed position, as shown in FIG. 2, the tapered strike face 32 of the valve body 28 and the seal 38 engage the tapered sealing surface 34 of the valve seat 30, thereby preventing fluid from flowing past the valve seat 30. When in the open position, as shown in FIG. 3, the valve 12 or 14 is spaced from the valve seat 30, thereby allowing the fluid to flow through the valve seat 30 and around the valve 12 or 14.

As discussed above, the fluid end 10 is designed to operate at high flow rates and fluid pressures. As a result, fluid contacting the tapered strike face 32 of the valve body 28 is known to wear and erode areas of the strike face 32 over time. Such erosion may prevent the strike face 32 from properly sealing against the valve seat 30, thereby allowing fluid to leak around the valve 12 of 14 when in the closed position. If the valve 12 or 14 starts to leak, it must be replaced. The sooner the valve 12 or 14 leaks, the shorter the time between maintenance intervals during operation, costing valuable operating time and money.

Continuing with FIGS. 2 and 3, the worst wear occurs at the initial opening of the valve 12 or 14. As fluid pressure increases, shown by arrows 37 in FIG. 2, the valve 12 or 14 starts to open, the annular space between the strike face 32 and the tapered sealing surface 34 or the “initial fluid pathway” has a minimal cross-sectional area for fluid flow. The minimal cross-sectional area restricts the flow of fluid along the initial fluid pathway, causing fluid to flow at a maximum fluid velocity. The high fluid velocity contacting the strike face 32 along the initial fluid pathway causes the strike face 32 to wear and eventually erode.

As the valve 12 or 14 opens to a point of maximum separation from the valve seat 30, the fluid velocity is decreased, as there is more area for fluid to flow, shown by the fluid arrows 39 in FIG. 3. Thus, areas of the valve 12 or 14 not exposed to the initial high fluid velocity experience less wear over time. There is a need in the art for a valve configured to incur less wear to its strike face during operation.

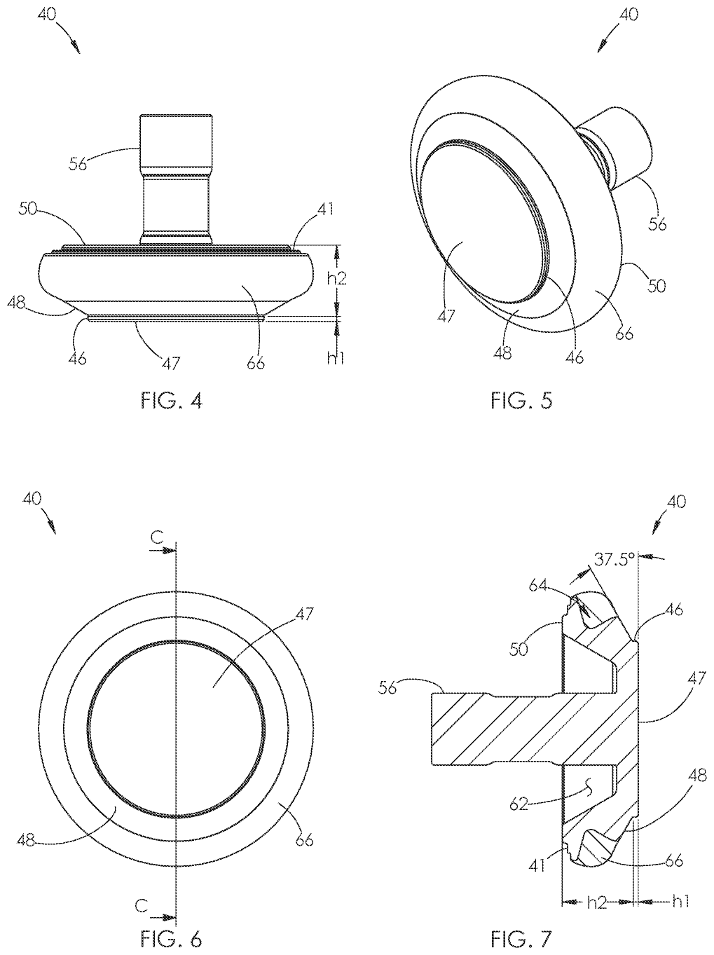

Turning now to FIGS. 4-10, one embodiment of a valve 40 disclosed herein is shown. The valve 40 may be used in place of the suction valve 12 or the discharge valve 14 shown in FIG. 1. The valve 40 is similar to the valve 12 or 14, but the valve 40 comprises a nose 46 joined to the valve's strike face 48, as shown in FIGS. 4-7. As will be described herein, the nose 46 is configured to increase the initial cross-sectional flow area between the valve 40 and the valve seat 30 during operation. Increasing the cross-sectional flow area between the valve 40 and the valve seat 30 reduces the initial velocity of fluid contacting the strike face 48, thereby reducing erosion to the strike face 48 and increasing the life of the valve 40.

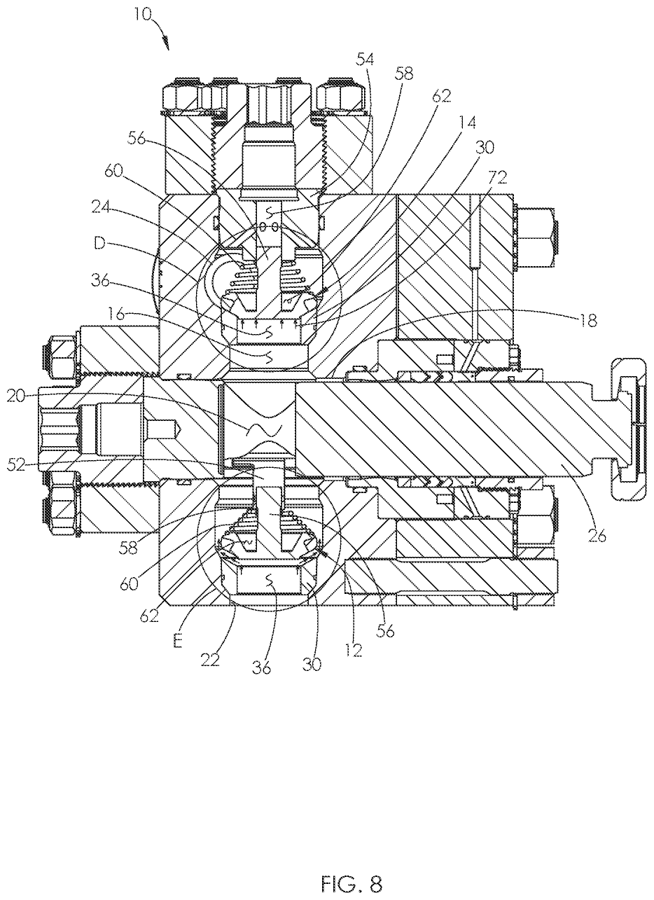

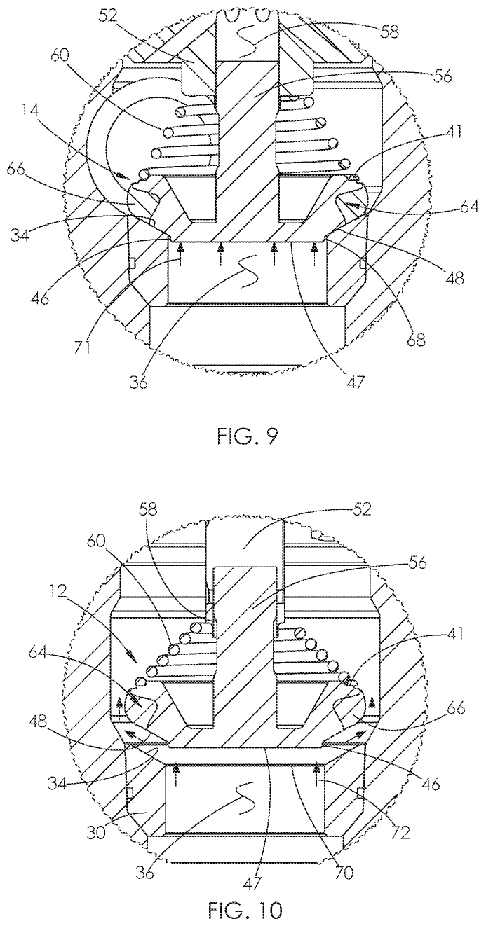

Continuing with FIGS. 4-7, the valve 40 comprises a valve body 50 joined to the nose 46. An outer surface of the valve body 50 comprises the tapered sealing surface or strike face 48. The strike face 48 is sized and shaped to seal against the tapered sealing surface 34 of the valve seat 30, as shown in FIGS. 8-10. The nose 46 has a generally cylindrical shape and is joined to a lower end of the valve body 50 such that all or at least a portion of the nose 46 extends into the central fluid bore 36 of the valve seat 30 when the valve 40 is in a closed position, as shown in FIG. 9.

Continuing with FIGS. 4-7, the nose 46 has a height, h1, and the height h1 of the nose 46 may vary but is preferably less than ¼ of a height, h2 of the valve body 50, as shown in FIG. 4. In alternative embodiments, the height, h1 of the nose 46 may be between ¼ and ½ of the height, h2 of the valve body 50. The strike face 48 is positioned at an angle relative to a base 47 of the nose 46. In FIGS. 4-7, this angle is 37.5 degrees. However, in alternative embodiments, this angle may be 30 degrees or any angle needed to match the size and shape of the tapered sealing surface 34 of the valve seat 30.

Continuing with FIGS. 4-7, the valve 40, and the valves 12 and 14, are known in the art as “stem-guided valves”, which means that movement of the valve 40 between open and closed positions is guided by a stationary valve retainer 52 or a stationary discharge plug 54, as shown in FIGS. 1 and 8. The valve 40 further comprises a stem 56 projecting from the valve body 50 opposite the nose 46 that is configured to reciprocate within a bore 58 formed in the valve retainer 52 or the discharge plug 54. During operation, the valve 40 is biased in the closed position by a spring 60 that extends between the valve body 50 and the valve retainer 52 or the discharge plug 54. The spring 60 engages an outer rim 41 of the valve body 50 and surrounds the stem 56, as shown in FIGS. 8-10.

Continuing with FIGS. 4-7, the valve body 50 further comprises an annular void 62 surrounding the stem 56. The annular void 62 is joined to the strike face 48 by the outer rim 41, as shown in FIG. 7. The annular void 62 reduces the weight of the valve body 50. The strike face 48 further comprises a cutout 64 sized to receive a seal 66. The cutout 64 and seal 66 are described in more detail in U.S. patent application Ser. No. 17/984,406, authored by Thomas et al., the entire contents of which are incorporated herein by reference. During operation, a portion of the seal 66 and a portion of the strike face 48 engage the tapered sealing surface 34 of the valve seat 30.

Turning to FIGS. 9 and 10, when the valve 40 is sealed against the valve seat 3o, the nose 46 is positioned entirely within the central fluid bore 36 of the valve seat 30, as shown in FIG. 9. Except for a small gap 68 between an outer surface of the nose 46 and a wall or walls surrounding the central fluid bore 36 which may expose a portion of the strike face 48, no portion of the strike face 48 extends into the central fluid bore 36. The small gap 68 ensures that the nose 46 will not contact any portion of the tapered sealing surface 34 as the valve 40 moves between open and closed positions.

Continuing with FIGS. 9 and 10, as the fluid pressure, shown by arrows 71, forces the valve 40 to separate from the valve seat 30, little to no fluid is allowed to flow between the strike face 48 and the tapered sealing surface 34 or along the initial fluid pathway until a base 47 of the nose 46 clears an opening 70 of the central fluid bore 36, as shown in FIG. 10. The base 47 is considered to be clear of the opening 70 or no longer positioned within the central fluid bore 36 once the vertical position of the base 47 is above the opening or transition line 70 between the central fluid bore 36 and the tapered sealing surface 34. At this point, the distance between the strike face 48 and the tapered sealing surface 34 of the valve seat 30 is large enough that the cross-sectional flow area is much larger, thereby reducing the velocity of fluid contacting the strike face 48, as shown by the fluid flow arrows 72 in FIG. 10. Thus, fluid is not allowed to flow along the initial fluid pathway until the annular cross-sectional area of the initial fluid pathway is already at or close to its maximum size. Reducing the velocity of fluid contacting the strike face 48 reduces wear and erosion to both the strike face 48 and the tapered sealing surface 34 over time. Reduced wear increases the life of the valve 40 and increases the time between maintenance intervals during operation.

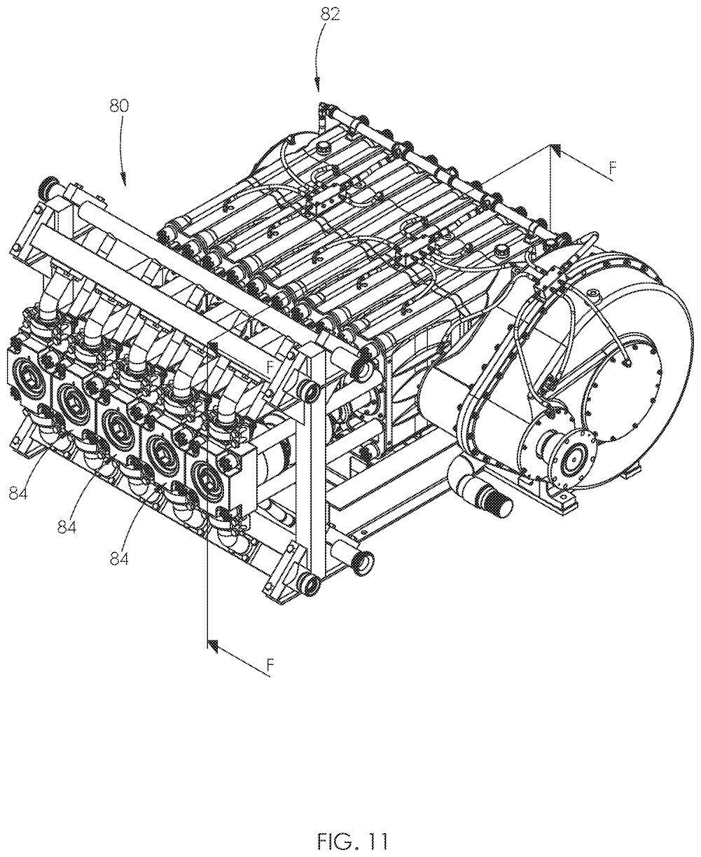

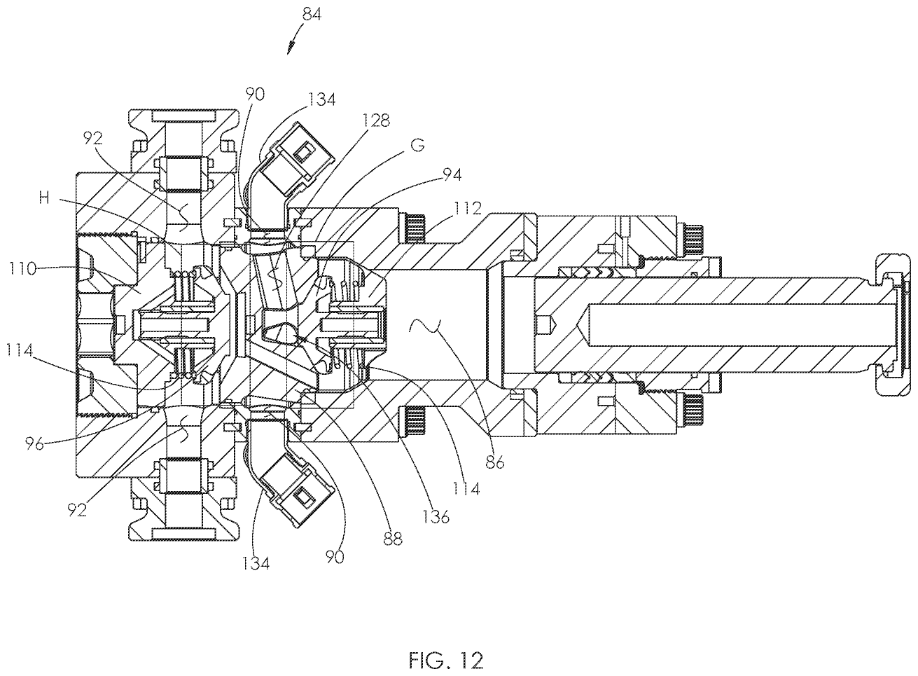

Referencing now FIGS. 11 and 12, another embodiment of a fluid end 80 is shown attached to one embodiment of a power end assembly 82. The fluid end 80 comprises a plurality of fluid end sections 84 positioned in a side-by-side relationship. Each fluid end section 84 has a single horizontal bore 86 formed therein, as shown in FIG. 12. Fluid is routed throughout the horizontal bore 86 using a fluid routing plug 88. Fluid enters the fluid end section 84 through one or more intake or suction bores 90 and discharges from the fluid end section 84 through one or more discharge bores 92.

Continuing with FIG. 12, fluid flow through the fluid routing plug 88 is controlled by another embodiment of an intake or suction valve 94 and another embodiment of a discharge valve 96 disclosed herein. The valves 94 and 96 engage opposite ends of the fluid routing plug 88 such that the fluid routing plug 88 functions as a valve seat. Thus, the fluid routing plug 88 may be characterized as a “component” that the valves 94 and 96 are configured to seal against. The valves 94 and 96 shown in FIG. 12 are stem-guided valves and are similar to one another but may vary in size in shape. The fluid end 80 and power end 82 shown in FIGS. 11 and 12 are described in more detail in U.S. Patent Publication No. 2022/0389916, authored by Keith et al., the entire contents of which are incorporated herein by reference.

Continuing with FIGS. 12 and 15-18, the suction and discharge valves 94 and 96 are like the valve 40 shown in FIGS. 4-7. However, the valves 94 and 96 are sized and shaped to mate with the fluid routing plug 88 instead of the valve seat 30. Like the valve 40, the suction and discharge valves 94 and 96 each comprise a valve body 98 joined to a nose 100. The valve body 98 further comprises a strike face or tapered sealing surface 102 having a cutout 99 formed therein. The cutout 99 is sized to receive a seal 104.

Continuing with FIGS. 12 and 15-18, each valve body 98 further comprises a stem 106 surrounded by an annular void 108. The stem 106 is configured to reciprocate within a discharge plug 110 or a suction valve guide 112 in FIG. 12. A spring 114 surrounds the stem 106 and engages an outer rim 116 of the valve body 98. In contrast to the valve 40, a central opening 118 may be formed in the stem 106 for collecting fluid during operation. The central opening 118 provides space for fluid or proppants to collect to not get trapped between moving parts.

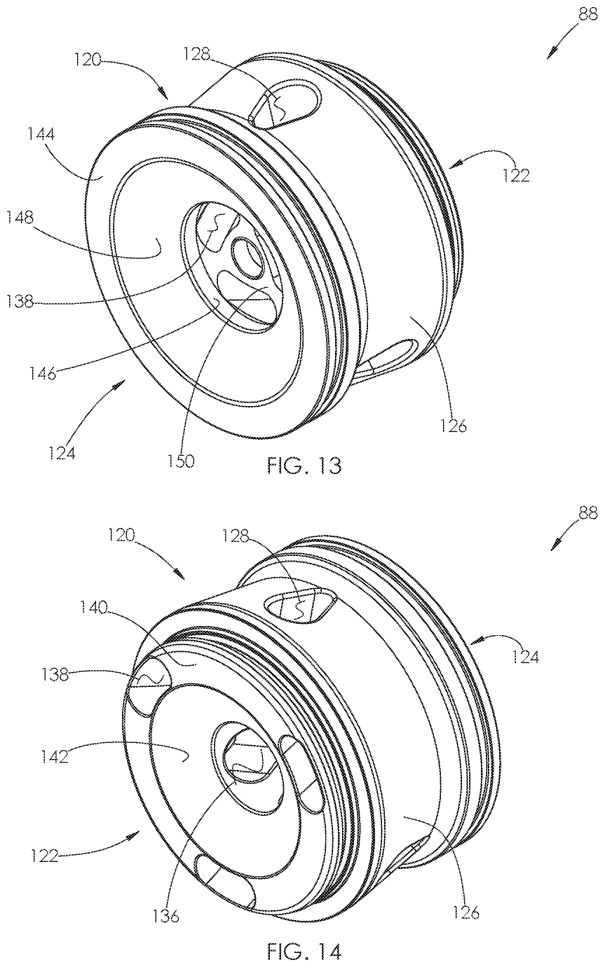

Turning now to FIGS. 13 and 14, the fluid routing plug 88 comprises a body 120 having a suction surface 122 and an opposed discharge surface 124 joined by an outer intermediate surface 126. The body 120 further comprises a plurality of fluid suction passages 128 that interconnect the intermediate surface 126 and the suction surface 122 of the body 120. The connection is formed within an axially blind bore 136 formed within the suction surface 122 of the body 120. During operation, fluid enters the suction bores 90 through a suction conduit 134 and then flows into the suction passages 128 of the fluid routing plug 88 and into the axially blind bore 136, as shown in FIG. 12. From there, fluid flows towards the suction surface 122 of the body 120 and out of the fluid routing plug 88.

Continuing with FIGS. 13 and 14, the body 120 of the fluid routing plug 88 further comprises a plurality of fluid discharge passages 138. The discharge passages 138 interconnect the suction surface 122 and discharge surface 124 of the body 120 and do not intersect any of the suction passages 128. In operation, fluid exiting the body 120 at the suction surface 122 is subsequently forced into the discharge passages 138, towards the discharge surface 124 of the body 120, and out of the fluid routing plug 88.

Continuing with FIGS. 13 and 14, the suction surface 122 of the fluid routing plug body 120 comprises an outer rim 140 joined to the axially blind bore 136 by a tapered sealing surface 142. Similarly, the discharge surface 124 comprises an outer rim 144 joined to a counterbore 146 by a tapered sealing surface 148. The discharge passages 138 open at a base 150 of the counterbore 146. Thus, high velocity fluid enters the counterbore 146 before exiting the fluid routing plug 88.

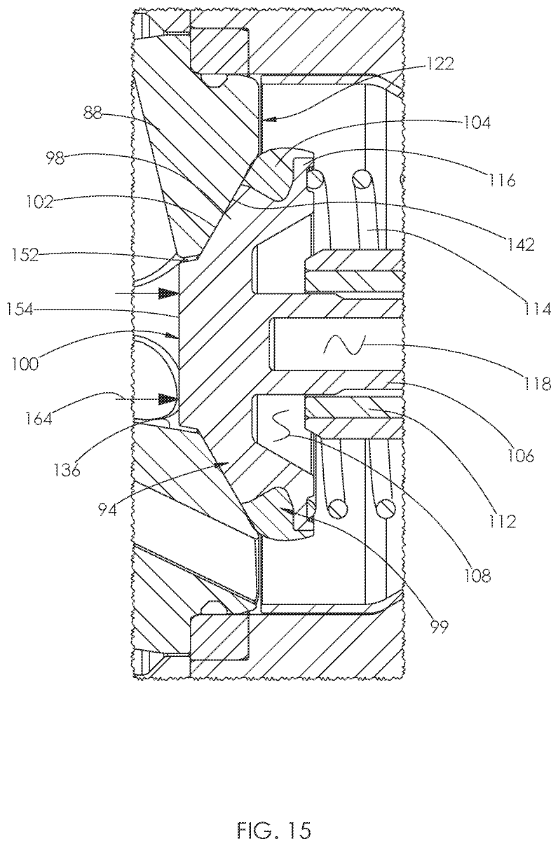

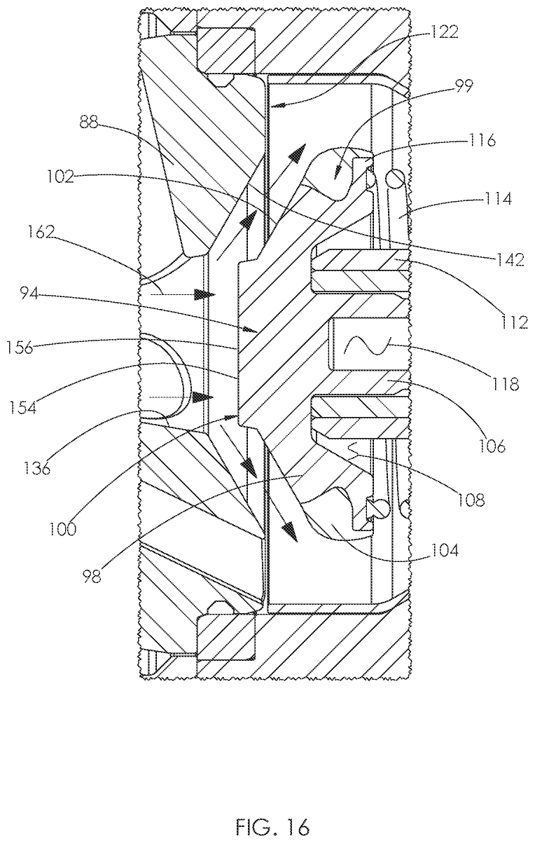

Turning to FIGS. 15 and 16, when the suction valve 94 is sealed against the suction surface 122 of the fluid routing plug 88, the nose 100 is entirely installed within the axially-blind bore 136, as shown in FIG. 15. With the exception of a small annular gap 152, the strike face 102 of the valve body 98 is not disposed within the axially-blind bore 136. The axially-blind bore 136 may thus be considered akin to the central fluid bore 36 of the valve seat 30 and may be characterized as such herein. The gap 152 ensures that the nose 100 does not contact any portion of the tapered sealing surface 142 as the suction valve 94 moves between open and closed positions.

Continuing with FIGS. 15 and 16, as the fluid pressure, represented by arrows 164, forces the suction valve 94 to separate from the fluid routing plug 88, little to no fluid is allowed to flow between the strike face 102 and the tapered sealing surface 142 or the initial fluid pathway until a base 154 of the nose 100 clears an opening 156 of the axially-blind bore 136. The base 154 is considered to be clear of the opening 156 or no longer positioned within the axially-blind bore 136 once the horizontal position of the base 154 is to the right of the opening or a transition line 156 between the axially-blind bore 136 and the tapered sealing surface 142, as shown in FIG. 16.

At this point, the distance between the strike face 102 and the tapered sealing surface 142 of the suction surface 122 of the fluid routing plug 88 is large enough that the cross-sectional flow area is much larger, thereby reducing the velocity of fluid contacting the strike face 102, as shown by the fluid flow arrows 162 in FIG. 16. Thus, fluid is not allowed to flow along the initial fluid pathway until the annular cross-sectional area of the initial fluid pathway is already at or close to its maximum size. Like the valve 40, reducing the velocity of fluid flow contacting the strike face 102 reduces wear and erosion to the suction valve 94 over time, thereby increasing the life of the suction valve 94.

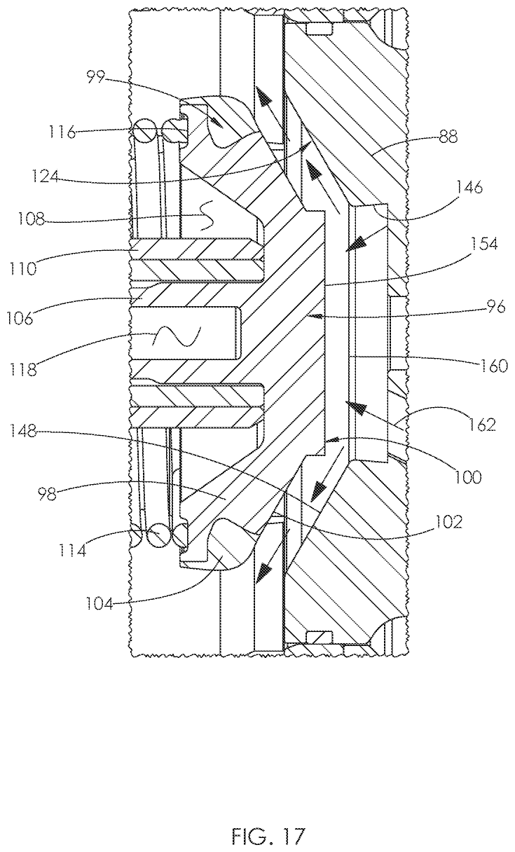

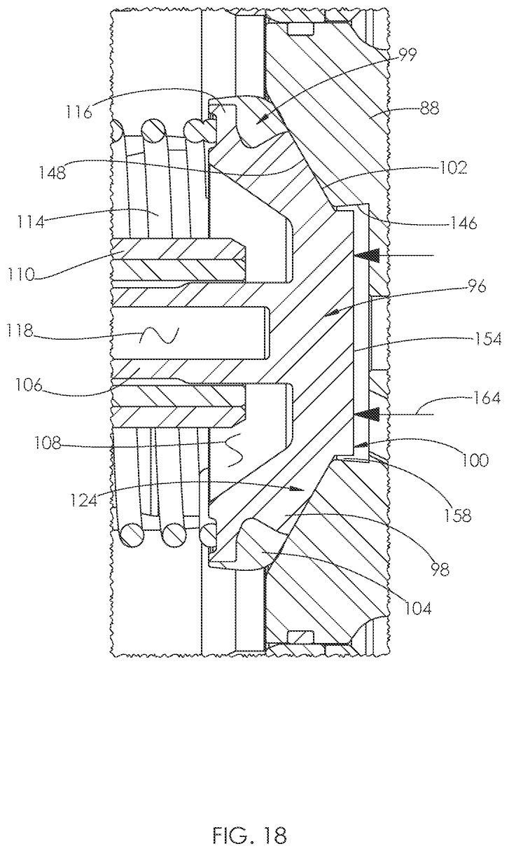

Turning to FIGS. 17 and 18, when the discharge valve 96 is sealed against the discharge surface 124 of the fluid routing plug 88, the nose is entirely installed within the counterbore 146, as shown in FIG. 18. With the exception of a small annular gap 158, the strike face 102 of the discharge valve 96 is not disposed within the counterbore 146. The counterbore 146 may thus be considered akin to the central fluid bore 36 of the valve seat 30, and may be characterized as such herein. The gap 158 ensures that the nose 100 does not contact any portion of the tapered sealing surface 142 as the discharge valve 96 moves between open and closed positions.

Continuing with FIGS. 17 and 18, as the fluid pressure, represented by arrows 164, forces the discharge valve 96 to separate from the fluid routing plug 88, little to no fluid is allowed to flow between the strike face 102 and the tapered sealing surface 148 or the initial fluid pathway until a base 154 of the nose 100 clears an opening 160 of the counterbore 146, as shown in FIG. 17. The base 154 is considered to be clear o the opening 160 or no longer positioned within the counterbore 146 once the horizontal position of the base 154 is to the left of the opening or a transition line 160 between the counterbore 146 and the tapered sealing surface 148, as shown in FIG. 17.

At this point, the distance between the strike face 102 and the tapered sealing surface 148 of the discharge surface 124 of the fluid routing plug 88 is large enough that the cross-sectional flow area is much larger, thereby reducing the velocity of fluid contacting the strike face 102, as shown by the fluid flow arrows 162 in FIG. 17. Thus, fluid is not allowed to flow along the initial fluid pathway until the annular cross-sectional area of the initial fluid pathway is already at or close to its maximum size. Like the valve 40, reducing the velocity of fluid contacting the strike face 102 reduces wear and erosion to the discharge valve 96 over time, thereby increasing the life of the discharge valve 96.

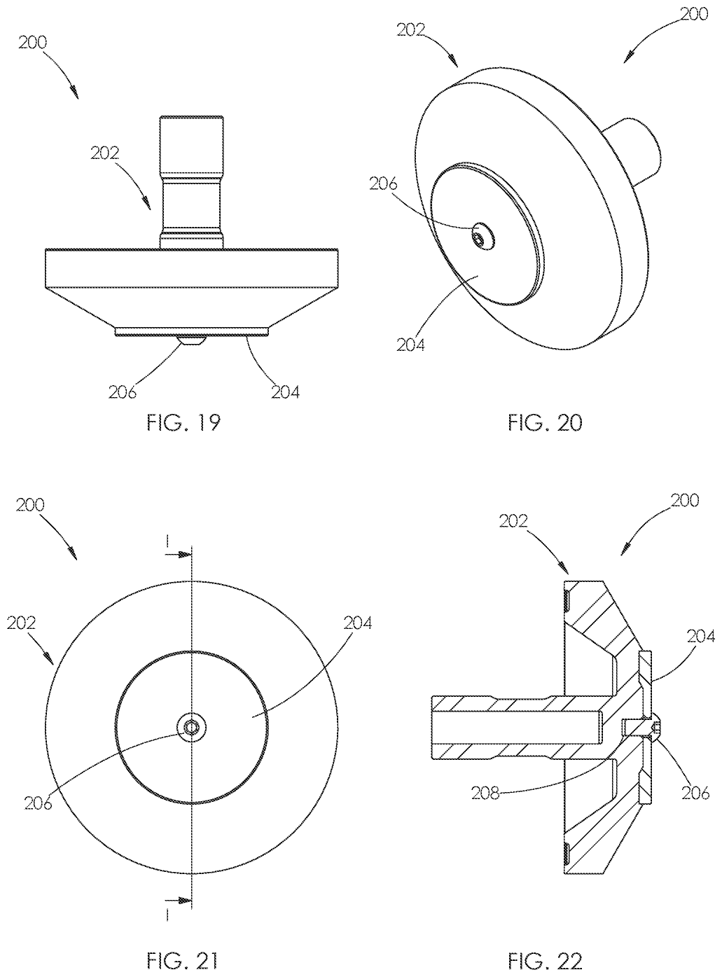

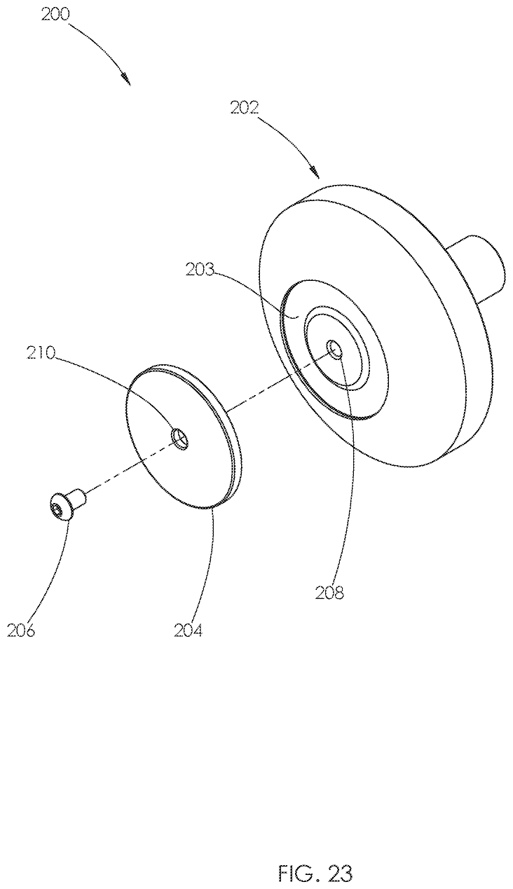

Turning to FIGS. 19-23, another embodiment of a valve 200 disclosed herein is shown. The valve 200 is similar to the valve 40 shown in FIGS. 4-7, but it comprises a removeable nose 204 instead of the integrally formed nose 46. Like the valve 40, the valve 200 may be used as a suction or discharge valve. The valve 200 comprises a valve body 202 joined to the nose 204 by a fastener 206. The valve body 202 is different from valve body 50 in that it comprises a central threaded opening 208 configured to mate with the fastener 206. The valve body 202 may also include a cutout 203 configured to receive a portion of the nose 204, as shown in FIG. 23. The cutout 203 helps properly align the nose 204 to the valve body 202. The replaceable nose 204 also comprises a central opening 210 that is configured to hold the fastener 206. While not shown herein, the valve body 202 may further comprise a seal, like the seal 66 shown in FIGS. 4-7.

In operation, this embodiment performs the same as the embodiments previously described. However, this embodiment allows the nose 204 to be replaced when it is eroded to the point that it no longer operates satisfactorily. Additionally, the nose 204 may be formed of a different material than the rest of the valve 200. The material of the nose 204 may be harder such as carbide or it may be softer such as a polyurethane. The material of the nose 204 may be changed to suit the specific fluid being used by the pump to maximize the life of the valve. The fastener 206 shown in FIGS. 19-23 is a button head hex drive screw, but any suitable fastener configured to retain the replaceable nose 204 to the valve body 202 may also be used.

In alternative embodiments, the nose 204 may not be replaceable, but may be made of a different material and permanently attached to the valve body 202 such that the valve body 202 and the nose 204 are made of multi-piece construction. Attachment methods whether permanent or not may include any method that will retain the nose 204 to the valve body 202. Without limiting the invention, these methods may include welding, brazing, adhesives, roll pins, and the like.

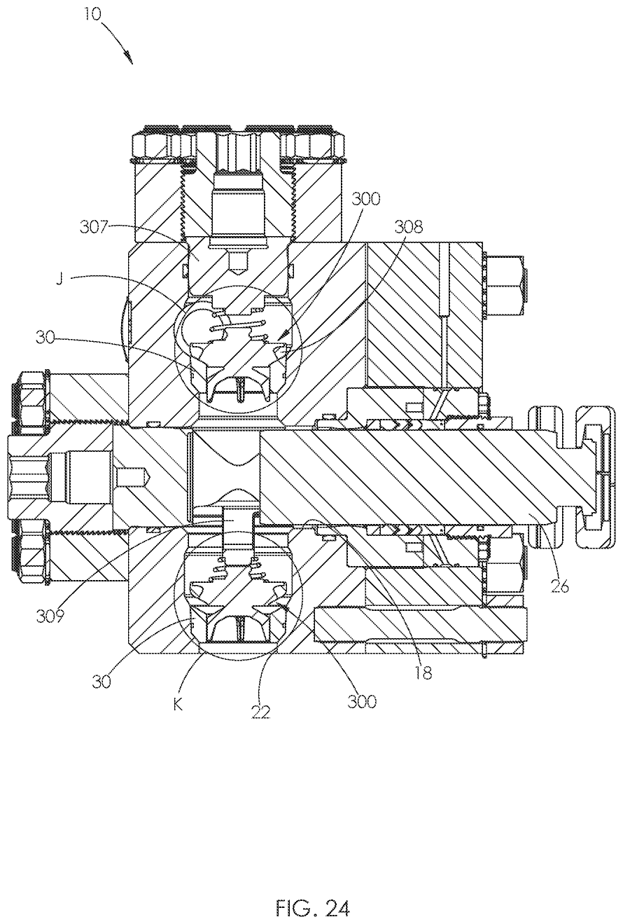

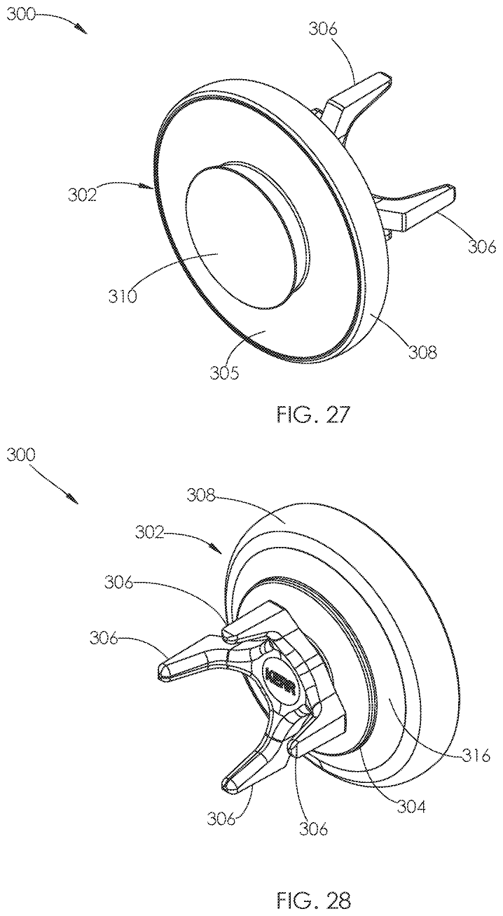

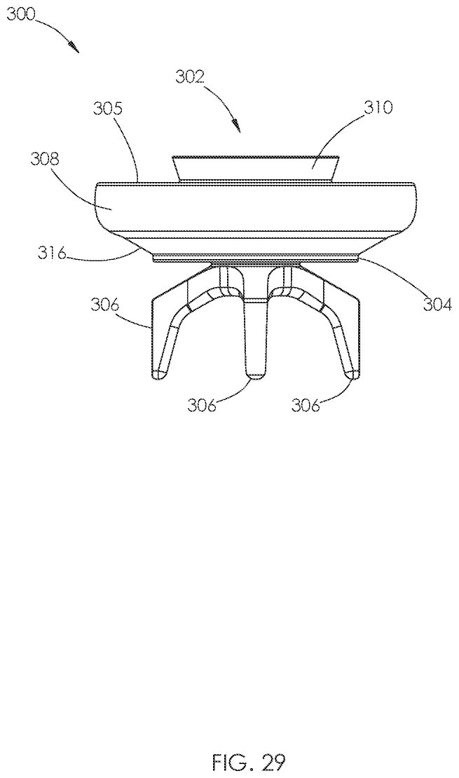

Turning to FIGS. 24-29, another embodiment of a valve 300 described herein is shown in the same fluid end 10 disclosed in FIG. 8. The valve 300 comprises a valve body 302 joined to a nose 304. A plurality of guide legs 306 extend from the nose 304. The valve body 302 further comprises a strike face 316 extending between the nose 304 and an upper surface 305 of the valve body 302. A seal 308 may be installed within a cutout 318 formed within the strike face 316 and engage a portion of the valve seat 30 during operation.

Continuing with FIGS. 24-29, the valve 300 is known in the art as a “leg-guided valve,” meaning that instead of using a stem, the valve 300 is centered on the valve seat 30 using a plurality of guide legs 306 that extend into the central fluid bore 36 at the valve seat 30. Because the valve 300 does not use a reciprocating stem, a discharge plug 307 and a valve retainer 309, which are installed within the fluid end 10, do not include a bore for the stem. Instead, the discharge plug 307 and the valve retainer 309 engage an upper boss 310 of the valve body 302 as the valve 300 moves into a fully opened position.

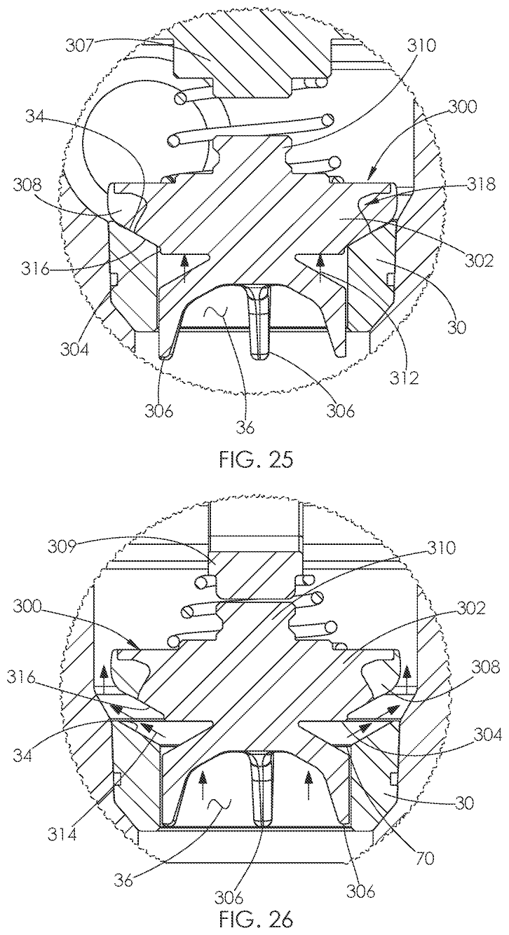

As mentioned, the plurality of legs 306 are configured to center the valve 300 within the central fluid bore 36 formed in the valve seat 30 and ensure that the valve 300 is properly aligned within the valve seat 30 during operation. When the valve 300 is sealed against the valve seat 30, the entire nose 304, in addition to the legs 306, are disposed within the central fluid bore 36, as shown in FIG. 25. The nose 304 provides the same advantages as the noses 46, 100, and 204.

Specifically, once fluid pressure, represented by arrows 312, begins to lift the valve 300, the nose 304 prevents significant fluid flow through the space between the strike face 316 and the tapered sealing surface 34 or the initial fluid pathway. The restriction of fluid flow is maintained until the nose 304 is lifted above the opening or transition 70 between the central fluid passage 36 and the tapered sealing surface 34 of the valve seat 30. Once the nose 304 reaches this position, fluid flow is no longer significantly restricted. At this point, the fluid flow between the strike face 316 and the tapered sealing surface 34 begins at a lower fluid velocity because the cross-sectional fluid area is larger, as shown by arrows 314 in FIG. 26.

In alternative embodiments, the nose 304 may be configured to be replaceable, like the nose 204 shown in FIG. 23. In such embodiment, the guide legs 306 may be joined to the replaceable nose, or the nose may be configured to be attached around the guide legs 306. The nose may be made of multiple pieces.

One or more kits may be useful with the valves disclosed herein. A kit may comprise the valve seat 30 and one of the valves 40, 94, 96, 200, or 300 disclosed herein. A kit may also comprise the valve body 202 and the separate nose 204. A kit may further comprise one or more of the other components described herein.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. An apparatus, comprising:
a valve configured to seal against a component, the component having a first tapered sealing surface joined to a central fluid bore; the valve comprising:
a valve body having a nose;
in which the valve body comprises a second tapered sealing surface configured to seal against the first tapered sealing surface; and
in which the nose has a cylindrical shape and is sized to be closely received within at least a portion of the central fluid bore.

2. The apparatus of claim 1, in which the component is a fluid routing plug and the central fluid bore is a counterbore formed in a discharge surface of the fluid routing plug.

3. The apparatus of claim 1, in which the component is a fluid routing plug and the central fluid bore is an axially-blind bore formed in a suction surface of the fluid routing plug.

4. The apparatus of claim 1, in which the component is a valve seat and the central fluid bore is a through-bore that extends entirely through the valve seat.

5. The apparatus of claim 1, in which the valve body further comprises:
a stem projecting from the valve body, the stem configured to be disposed within a spring.

6. The apparatus of claim 5, in which an annular void is formed in the valve body surrounding the stem.

7. The apparatus of claim 1, in which the valve body further comprises:
a plurality of legs extending from the nose and configured to be closely received within the central fluid bore.

8. The apparatus of claim 1, in which the nose is a separate piece from the valve body and is joined to the valve body using a fastener.

9. The apparatus of claim 1, in which the nose is sized such that a gap exists between an outer surface of the nose and a wall or walls surrounding the central fluid bore when the nose is closely received within the portion of the central fluid bore.

10. The apparatus of claim 1, in which the valve body has a first height and the nose has a second height; and in which the second height is less than half of the value of the first height.

11. The apparatus of claim 1, in which the first and second sealing surfaces define an initial fluid pathway; and in which fluid within the central fluid bore is restricted from flowing along the initial fluid pathway until the nose has cleared an opening of the central fluid bore.

12. A apparatus, comprising:
a valve seat, in which the valve seat is the component and in which the second tapered sealing surface is formed on the valve seat and the central fluid bore is a through-bore extending entirely through the valve seat; and
the valve of claim 1.

13. The valve of claim 12, in which the valve is movable between open and closed positions; in which the second tapered sealing surface of the valve body engages the first tapered sealing surface of the valve seat and the nose is disposed within the central fluid bore in the closed position; and in which the second tapered sealing surface is spaced from the first tapered sealing surface and the nose is spaced from the central fluid bore in the open position.

14. The valve of claim 13, in which no portion of the second tapered sealing surface is disposed within the central fluid bore when the valve is in a closed position.

15. A fluid end, comprising:
a housing having an external surface and an internal chamber;
a conduit formed in the housing and connecting the internal chamber to the external surface; and
the valve of claim 12 installed within the conduit.

16. The valve of claim 12, the valve body further comprising:
a plurality of legs extending from the nose and configured to be closely received within the central fluid bore of the valve seat.

17. A fluid end, comprising:
a housing having a horizontal bore extending therethrough;
a fluid routing plug installed within the horizontal bore, the fluid routing plug comprising:
a body having a suction surface and an opposed discharge surface and a central longitudinal axis that extends through the suction and discharge surfaces; and
a plurality of fluid passages formed in the body;
the valve of claim 1 installed within the horizontal bore and facing the discharge surface of the fluid routing plug;
in which the fluid routing plug is the component; and
in which the first tapered sealing surface is formed on the discharge surface and the central fluid bore is a counterbore formed in the discharge surface of the fluid routing plug.

18. The valve of claim 17, in which the valve is movable between open and closed positions; in which the second tapered sealing surface of the valve body engages the first tapered sealing surface of the fluid routing plug and the nose is disposed within the counterbore in the closed position; and in which the second tapered sealing surface is spaced from the first tapered sealing surface and the nose is spaced from the counterbore in the open position.

19. A fluid end, comprising:
a housing having a horizontal bore extending therethrough;
a fluid routing plug installed within the horizontal bore, the fluid routing plug comprising:
a body having a suction surface and an opposed discharge surface and a central longitudinal axis that extends through the suction and discharge surfaces; and
a plurality of fluid passages formed in the body;
the valve of claim 1 installed within the horizontal bore and facing the suction surface of the fluid routing plug;
in which the fluid routing plug is the component; and
in which the first tapered sealing surface is formed on the suction surface and the central fluid bore is an axially-blind bore formed in the suction surface of the fluid routing plug.

20. The valve of claim 19, in which the valve is movable between open and closed positions; in which the second tapered sealing surface of the valve body engages the first tapered sealing surface of the fluid routing plug and the nose is disposed within the axially-blind bore in the closed position; and in which the second tapered sealing surface is spaced from the first tapered sealing surface and the nose is spaced from the axially-blind bore in the open position.
